(19) United States
(12) Patent Application Publication
(10) Pub. No.: US 2008/0299945 A1
(43) Pub. Date: Dec. 4, 2008

(54) METHOD FOR A MOBILE COMMUNICATION DEVICE TO SELECT A CHARGING SCHEME

(75) Inventors: Wen-Yi Kuo, Taipei (TW); Yueh-Feng Lee, Taoyuan City (TW); Yi-Hao Chang, Yong-Ho City (TW)

Correspondence Address: PAI PATENT & TRADEMARK LAW FIRM, 1001 FOURTH AVENUE, SUITE 3200, SEATTLE, WA, 98154, US

(73) Assignee: BANDRICH INC., SINDIAN CITY (TW)

(21) Appl. No.: 12/036,249

(22) Filed: Feb. 23, 2008

Related U.S. Application Data
(60) Provisional application No. 60/940,960, filed on May 30, 2007.

(51) Int. Cl. H04M 11/00

(52) U.S. Cl. 455/406

(57) ABSTRACT

A method for a mobile communication device to select a charging scheme is disclosed. The method can be implemented by a mobile communication device connecting to one of a plurality of foreign networks. The mobile communication device builds a connection with a home network through the connected foreign network. The home network sends charging scheme information to the mobile communication device by a communication method and the mobile communication device sends information of a selected charging scheme of a selected foreign network to the home network by the communication method. The mobile communication device then obtains services of the home network with the selected charging scheme through the selected foreign network.

### CROSS-REFERENCE TO RELATED APPLICATION

This application claims the priority benefit of U.S. Provisional Application Ser. No. 60/940,960, filed May 30, 2007, the full disclosures of which are incorporated herein by reference.

### BACKGROUND

1. Field of Invention

The present invention relates to a method for selecting a charging scheme. More particularly, the present invention relates to a method for a mobile communication device to select a charging scheme.

2. Description of Related Art

Mobile communication devices are famous for their convenience. Therefore, users may carry their mobile communication devices to other countries and use services of the home network there. In order to provide services to its users through a foreign network, the home network provider must have roaming agreements with the foreign network providers for the amenable users to subscribe to the roaming service with the foreign network. Once the subscription is completed, the charging scheme of the roaming service is fixed. However, different foreign network providers may have different charging schemes for roaming services. Moreover, a foreign network provider may have several charging schemes for roaming services. The charge fees of these charging schemes may be calculated by packets or by communication time. Therefore, users have to check information of different charging schemes before going abroad.

For the foregoing reason, there is a need for a method for a mobile communication device to be able to select a charging scheme.

### SUMMARY

According to one embodiment of the present invention, a method for a mobile communication device to select a charging scheme is provided. The method comprises steps of the mobile communication device connecting to one of a plurality of foreign networks. The mobile communication device builds a connection with a home network through the connected foreign network. The home network sends charging scheme information to the mobile communication device by a mobile communication method. The mobile communication device sends information of a selected charging scheme of a selected foreign network to the home network by the communication method. The mobile communication device obtains services of the home network with the selected charging scheme through the selected foreign network.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a block diagram of a connecting relation applying to a method for a mobile communication device to select a charging scheme according to one embodiment of this invention;

FIG. 2 is a flow diagram of a method for a mobile communication device to select a charging scheme according to a first embodiment of this invention;

FIG. 3 is a flow diagram of a method for a mobile communication device to select a charging scheme according to a second embodiment of this invention; and

FIG. 4 is a flow diagram of a method for a mobile communication device to select a charging scheme according to a third embodiment of this invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

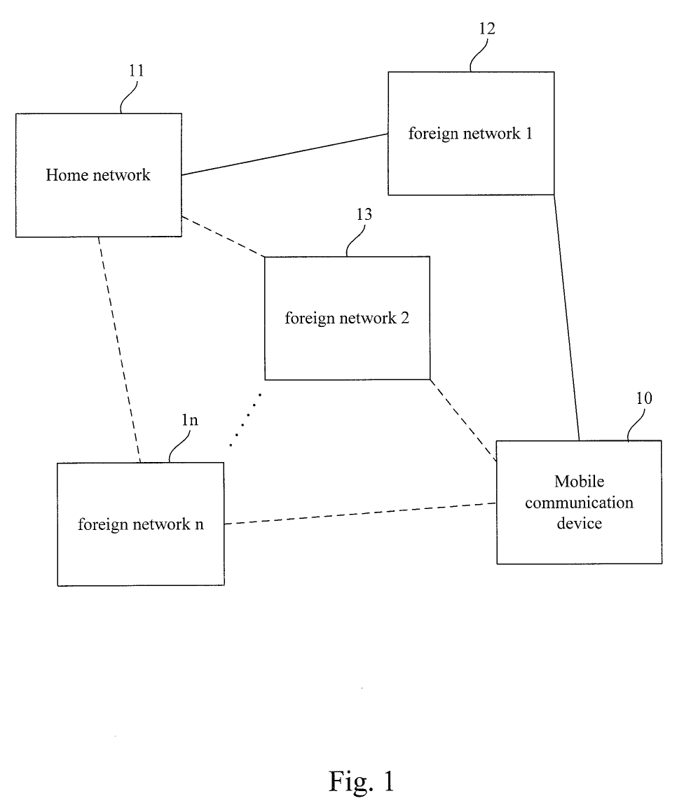

FIG. 1 is a block diagram of a connecting relation applying to a method for a mobile communication device to select a charging scheme according to one embodiment of this invention. A mobile communication device 10 obtains services of the home network 11 through one of a plurality of foreign networks 12, 13, . . . 1n. Wherein the provider of the home network 11 has roaming agreements with the providers of the foreign networks 12, 13, . . . 1n to provide services to users of the home network 11.

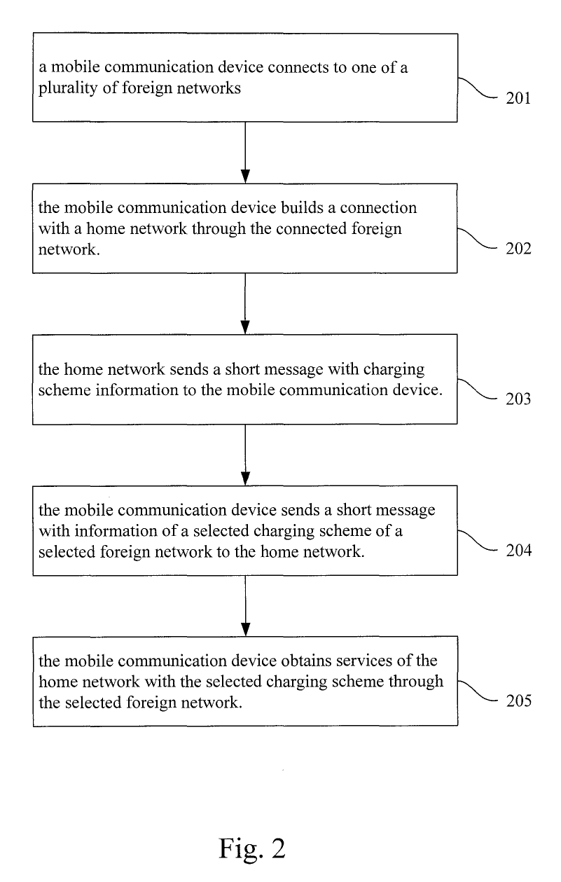

FIG. 2 is a flow diagram of a method for a mobile communication device to select a charging scheme according to a first embodiment of this invention. In step 201 a mobile communication device connects to one of a plurality of foreign networks. Wherein, the mobile communication device may determine the connected foreign network according to radio access technology and signal strength of the foreign networks during the connection process. In step 202, the mobile communication device builds a connection with a home network through the connected foreign network. In the next step, step 203, the home network sends a short message with charging scheme information of the foreign networks to the mobile communication device. Wherein the charging scheme information comprises how charging schemes charge. For example, the charge fees of the charging schemes may be calculated by packets or by communication time. Then, in step 204, the mobile communication device sends a short message with information of a selected charging scheme of a selected foreign network to the home network. Wherein the selected charging scheme of the selected foreign network is selected by a user or automatically selected by the mobile communication device, which is set by the user previously. In step 205, the mobile communication device obtains services of the home network with the selected charging scheme through the selected foreign network.

In the first embodiment, the mobile communication device connects to one of the foreign networks, obtains the charging scheme information through a short message service, replies with the information of the selected charging scheme of the selected foreign network using a short message service, and obtains the services of the home network with the selected charging schemes through the selected foreign network.

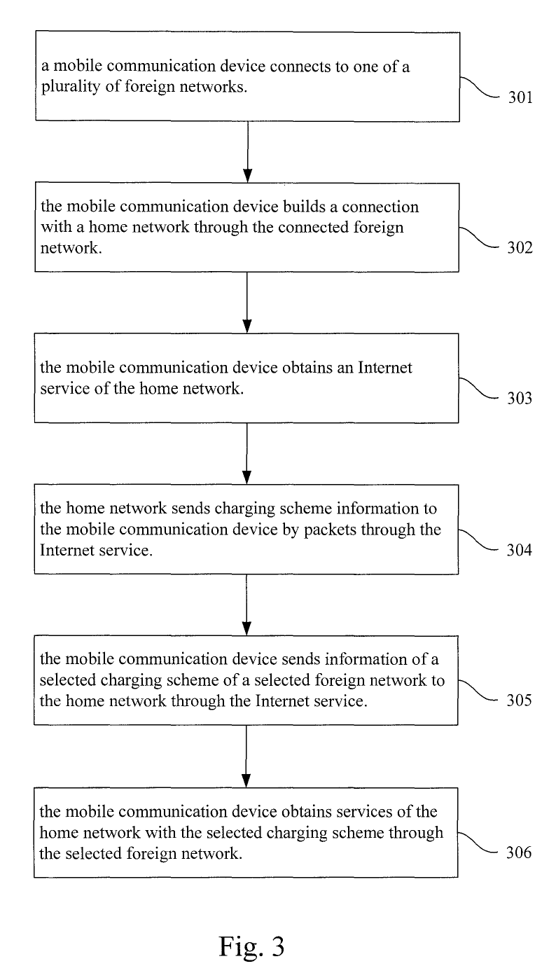

FIG. 3 is a flow diagram of a method for a mobile communication device to select a charging scheme according to a second embodiment of this invention. In step 301 in which a mobile communication device connects to one of a plurality of foreign networks. Wherein, the mobile communication device may determine the connected foreign network according to radio access technology and signal strength of the foreign networks during the connection process. In step 302, the mobile communication device builds a connection with a home network through the connected foreign network. In the next step, step 303, the mobile communication device obtains an Internet service of the home network. Then, in step 304, the home network sends charging scheme information of the foreign networks to the mobile communication device by packets through the Internet service. Wherein the charging scheme information comprises how charging schemes charge. For example, the charge fees of the charging schemes may be calculated by packets or by communication time. In step 305, the mobile communication device sends information of a selected charging scheme of a selected foreign network to the home network through the Internet service. Wherein the selected charging scheme of the selected foreign network is selected by a user or automatically selected by the mobile communication device, which is set by the user previously. In step 306, the mobile communication device obtains services of the home network with the selected charging scheme through the selected foreign network.

In the second embodiment, the mobile communication device connects to one of the foreign networks to obtain the Internet service of the home network, obtains the charging scheme information through the Internet service, replies with the information of the selected charging scheme of the selected foreign network through the Internet service to the home network, and obtains the services of the home network with the selected charging scheme through the selected foreign network.

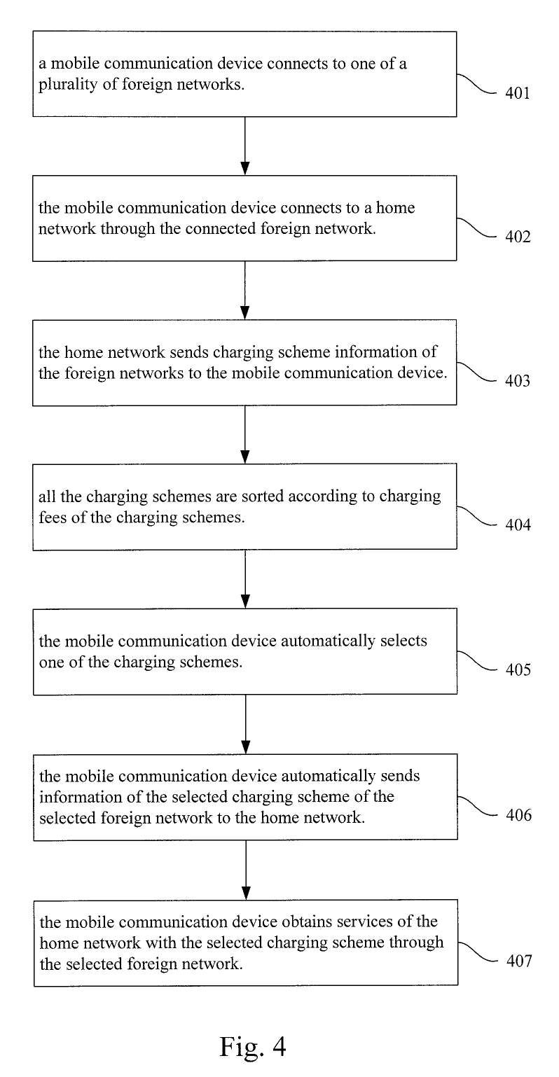

FIG. 4 is a flow diagram of a method for a mobile communication device to select a charging scheme according to a third embodiment of this invention. In step 401 in which a mobile communication device connects to one of a plurality of foreign networks. Wherein, the mobile communication device may determine the connected foreign network according to radio access technology and signal strength of the foreign networks during the connection process. In step 402, the mobile communication device connects to a home network through the connected foreign network. In the next step, step 403, the home network sends charging scheme information of the foreign networks to the mobile communication device. Wherein the charging scheme information comprises how charging schemes charge. For example, the charge fees of the charging schemes may be calculated by packets or by communication time. Moreover, the charging scheme information includes all the charging schemes of the foreign networks which have roaming agreements with the home network and belong to a same country or a same region where the connected foreign network belongs to. Then, in step 404, all the charging schemes are sorted according to charging fees of the charging schemes. In step 405, the mobile communication device automatically selects a selected charging scheme which charges the least from all of the charging schemes of the foreign networks, wherein the selected charging scheme belongs to a selected foreign network. In the next step, step 406, the mobile communication device automatically sends information of the selected charging scheme of the selected foreign network to the home network. Then, in step 407, the mobile communication device obtains services of the home network with the selected charging scheme through the selected foreign network.

In the third embodiment, the mobile communication device connects to one of the foreign networks to connect to the home network, obtains the charging scheme information, sorts the charging schemes, selects one of the charging schemes which charges least, sends the information of the selected charging scheme of the selected foreign network to the home network, and obtains the services of the home network with the selected charging scheme through the selected foreign network.

Several different advantages exist with these and other embodiments. Users can select by themselves the charging scheme for obtaining services of the home network through the foreign network. Besides, mobile communication device can also automatically select charging schemes for obtaining services of the home network through the foreign networks. Wherein, users set the selecting method of the mobile communication devices previously. Therefore, users can obtain services of the home network through the foreign network with suitable charging schemes by this invention.

Although the present invention has been described in considerable detail with reference to certain embodiments thereof, other embodiments are possible. Therefore, their spirit and scope of the appended claims should no be limited to the description of the embodiments container herein. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method for a mobile communication device to select a charging scheme, comprising steps of:
the mobile communication device connecting to one of a plurality of foreign networks;
the mobile communication device building a connection with a home network through the connected foreign network;
the home network sending charging scheme information to the mobile communication device by a communication method, wherein the charging scheme information comprises the information of a plurality of charging schemes of the foreign networks;
the mobile communication device sending information of a selected charging scheme of a selected foreign network to the home network by the communication method; and
the mobile communication device obtaining services of the home network with the selected charging scheme through the selected foreign network.

2. The method of claim 1, after the home network sends charging scheme information to the mobile communication device by the communication method, further comprising step of:
the mobile communication device prompting a user to select one of the charging schemes of the foreign networks as the selected charging scheme of the selected foreign network to make the mobile communication device obtain the services of the home network with the selected charging scheme through the selected foreign network.

3. The method of claim 1, after the home network sends charging scheme information to the mobile communication device by the communication method, further comprising the step of:
the mobile communication device selecting one of the charging schemes of the foreign networks, which charges least, as the selected charging scheme of the selected foreign network to make the mobile communication device obtain the services of the home network with the selected charging scheme through the selected foreign network.

4. The method of claim 1, wherein the communication method is a short message service (SMS).

5. The method of claim 1, wherein the communication method is an Internet service.

6. The method of claim 5, after the mobile communication device builds the connection with the home network through the connected foreign network, further comprising step of the mobile communication device obtaining the Internet service of the home network to make the home network send the charging scheme information to the mobile communication device through the Internet service.
